(19) United States
(12) Patent Application Publication
(10) Pub. No.: US 2017/0054182 A1
(43) Pub. Date: Feb. 23, 2017

(54) METHOD FOR PRODUCING A BATTERY CELL AND BATTERY CELL

(71) Applicant: Lithium Energy and Power GmbH & Co. KG, Stuttgart (DE)

(72) Inventors: Anselm Berg, Ludwigsburg (DE); Thomas Klemen, Ilsfeld/Auenstein (DE)

(21) Appl. No.: 15/240,164

(22) Filed: Aug. 18, 2016

(30) Foreign Application Priority Data
Aug. 18, 2015 (EP) 15181414.2

(51) Int. Cl. H01M 10/0587; H01M 2/20; H01M 2/06; H01M 2/02; H01M 10/0525; H01M 10/04

(52) U.S. Cl. CPC H01M 10/0587; H01M 10/0525; H01M 10/0431; H01M 2/06; H01M 2/0277; H01M 2/0285; H01M 2/206; H01M 2220/20

(57) ABSTRACT

A method for producing a battery cell (8) wherein, after the metallic bottom part (16) has been joined materially to the metallic wall part (14) and the second electrode side (28) has been joined materially to the feedthrough bushing (32), a metallic cover part (12) is joined materially to the metallic wall part (14), and wherein the material joining of the metallic bottom part (16) to the metallic wall part takes place only after the material joining of the first electrode side (26) of the battery roll (24) to the metallic bottom part (16).

### BACKGROUND OF THE INVENTION

The invention relates to a method for producing a battery cell, in particular a lithium-ion battery cell having a housing and an electric storage element arranged therein.

Battery cells, which are in some cases also referred to as accumulator cells, are used to store electric energy. Battery cells are already being used for supplying power to a large number of mobile devices. In future, battery cells are expected to be used inter alia for supplying power to electric vehicles or hybrid vehicles, on land or on water, or for static temporary storage of electric energy derived from alternative energy sources.

For this purpose, the general practice is to combine a large number of battery cells into battery packs or battery modules. In order to exploit an available pack volume as efficiently as possible in this case, battery cells with a prismatic, e.g. cuboidal, shape are primarily used for such purposes for reasons of useful volume.

There are already many different types of battery cells. However, conventional battery cells are generally of complex construction, where a large number of different individual parts are used to assemble the overall battery cell. In particular, production is both expensive and time-consuming where a large number of individual parts has to be assembled.

Because of its high energy density, thermal stability and lack of a memory effect, lithium-ion technology is generally used for applications such as motor vehicles, for example, and this is currently the subject of intensive development by virtue of its high economic significance for future electrically powered mobility.

In the interior of the housing of such lithium-ion cells there is a roll which has been pressed flat (a “jelly roll” or “coffee bag”), which is produced by winding an aluminum foil, a copper foil (these are coated with reactive cathode and anode materials) and two plastic films serving as diaphragms. After the introduction of the roll and before being closed in a pressure tight manner, the housing is filled with a liquid electrolyte.

DE 10 2011 076 919 A1 discloses that the housing of the battery cell has at least two housing elements substantially separating the electrode assembly from the environment. It is envisaged that a first housing element be connected electrically to the positive pole of the electrode assembly and that the second housing element be connected electrically to the negative pole of the electrode assembly, thus allowing electrical contact with the battery cell at the first housing element and at the second housing element.

DE 10 2011 082 288 A1 discloses an energy storage device having a housing in which at least two chambers, each intended to accommodate an energy storage device, are formed, and having at least two energy storage devices, which are connected in series and are each arranged in one of the chambers. From the illustrative embodiments, it is clear that the energy storage devices are directly electrically connected by means of the container of the housing and can be connected in series, and thus the container of the housing can act as a further pole for determining the individual voltages of the energy storage devices.

As is clear from DE 10 2013 201 572 A1, the essential element, the battery roll, is generally introduced into the housing. This requires lateral contacting by current collectors and further components. This is not optimal as regards usage of the volume with active material.

### SUMMARY OF THE INVENTION

A method for producing a battery cell comprising a housing and a battery roll arranged in the housing, wherein the battery roll has a first electrode side and a second electrode side, is proposed. The method comprises joining the first electrode side of the battery roll materially to a metallic bottom part of the housing before or after the introduction of the battery roll into a metallic wall part, and joining the second electrode side of the battery roll materially to a feedthrough bushing after the introduction of the battery roll into the metallic wall part, wherein, after the metallic bottom part has been joined materially to the metallic wall part and the second electrode side has been joined materially to the feedthrough bushing, a metallic cover part is joined materially to the metallic wall part, and wherein the material joining of the metallic bottom part to the metallic wall part takes place only after the material joining of the first electrode side of the battery roll to the metallic bottom part. Aluminum is particularly suitable as a metallic material for the housing or parts of the housing.

The second electrode side preferably has a contact tab and is joined materially to the feedthrough bushing via this contact tab, wherein the feedthrough bushing protrudes through the metallic cover part or the metallic wall part and is connected to a first terminal.

The metallic cover part preferably has a second terminal, which is mounted on the metallic cover part or integrated into the latter in the course of the method according to the invention.

As an alternative, the second terminal can also be connected to the metallic wall part in the course of the method according to the invention.

In the course of the method according to the invention, a box is formed from the metallic wall part and the metallic bottom part. The electrolyte can be introduced into the box before the metallic cover part is joined materially to the box, or it is introduced subsequently, through an opening provided in the metallic cover part, after the metallic cover part is joined materially to the box.

In the method according to the invention, a metallic wall part is used instead of a cell box produced by deep drawing. In order to avoid a short-circuit between the housing and the second electrode side of the battery roll, an insulating element is inserted between the metallic cover part of the housing and the contact tab of the second electrode side of the battery roll. For joining the battery roll materially to the metallic bottom part of the housing, the metallic bottom part contains a step and/or the first electrode side of the battery roll is enlarged in the direction of the metallic bottom part by a further contact tab. A battery connection of the battery cell according to the invention which is associated with the second electrode side of the battery roll of the battery cell comprises a sealing and insulating part, a terminal and a feedthrough bushing. In contrast, the battery connection which is associated with the first electrode side of the battery roll requires neither a sealing and insulating part nor a feedthrough bushing, and therefore, by means of the method according to the invention, the battery connection which is associated with the first electrode side of the battery roll of the battery cell is embodied without a seal and/or without additional components.

Another aspect of the invention relates to a battery cell produced by a method according to the invention. After the method has been carried out, the metallic bottom part and the box formed from the metallic wall part and the metallic bottom part are fully at a potential of the first electrode side and serve as current collectors.

A battery cell according to the invention is advantageously used in an electric vehicle (EV), in a hybrid vehicle (REV) or in a plug-in hybrid vehicle (PHEV). Use in consumer electronics or in power tools is also conceivable.

The battery cell according to the invention has the advantage that only a small number of components are required in the battery cell for electrical contacting of the electrodes. After the method according to the invention has been carried out, the housing is fully at the potential of the first electrode side and serves as a current collector. Thus, a battery connection on the first electrode side of the battery roll of the battery cell according to the invention has just one terminal, which is mounted directly on the metallic cover part or is integrated into the latter. Accordingly, the current collector, the seal and further components for the feedthrough bushing on the first electrode side of the battery roll of the battery cell are eliminated, leading to a considerable reduction in weight with correspondingly increased gravimetric energy content. Owing to the lower complexity and smaller number of components of the battery connection, the battery cell can be produced at lower cost.

According to the invention, the same advantages are obtained for the battery cell produced. By eliminating the components of the battery connection, it is possible to achieve more efficient use of the volume of the battery cell, that is to say that the battery cell can be made thinner, and it is thus possible to achieve an improved level of usage of the volume of the battery pack. Moreover, better sealing of the battery cell can be achieved by eliminating the components at the battery connection and materially joining the metallic bottom part, metallic wall part and metallic cover part.

It is furthermore advantageous that the design according to the invention makes it possible to transfer the structure of a cylindrical cell to a prismatic cell. As a result, maximum usage of volume is possible using traditional prismatic designs in accordance with the VDA standard (VDA=Verband der Automobilindustrie (German Motor Vehicle Manufacturers' Association)), e.g. a PHEV2 cell standardized by the VDA.

Another advantage of the battery cell according to the invention is that no new processes in comparison with existing concepts have to be integrated into production, and hence already existing plants can be used.

### BRIEF DESCRIPTION OF THE DRAWINGS

The invention is explained in greater detail below by means of a number of illustrative embodiments and of the associated drawings, in which:

FIG. 1 shows an exploded view of a battery arrangement known from the prior art,

FIG. 2 shows a perspective view of a battery cell according to the invention according to a first embodiment,

FIG. 3 shows a section through a battery cell according to the invention according to the first embodiment,

FIG. 3.1 shows a detail view of a battery connection of the battery cell according to the invention according to the first embodiment,

FIG. 4 shows a schematic illustration of a battery cell according to the invention according to a second embodiment,

FIG. 5 shows a perspective illustration of a battery cell according to the invention according to a third embodiment, and

FIG. 6 shows a schematic illustration of the method according to the invention.

### DETAILED DESCRIPTION

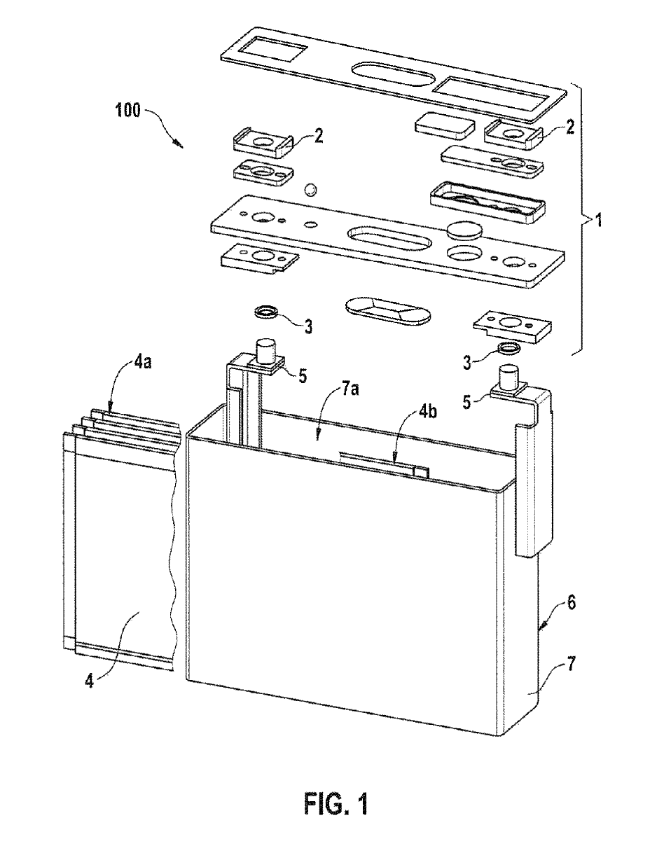

A battery arrangement 100 known from the prior art is shown in FIG. 1. The battery arrangement 100 comprises a cell housing 6, which is of prismatic design, in the present case of cuboidal design. In the present case, the cell housing 6 is of electrically conductive design and is manufactured from aluminum by deep drawing, for example. The cell housing 6 comprises a cuboidal container 7, which has a container opening 7a on one side. The container opening 7a is closed by a cover arrangement 1, which comprises two terminals 2, two seals 3 and a large number of other individual components.

From the illustration according to FIG. 1, it can be seen that there is an electrode roll 4 in the container 7, the anode 4a and cathode 4b of which roll are perpendicular to the container opening 7a and the cover opening 1 and are connected to two current collectors 5.

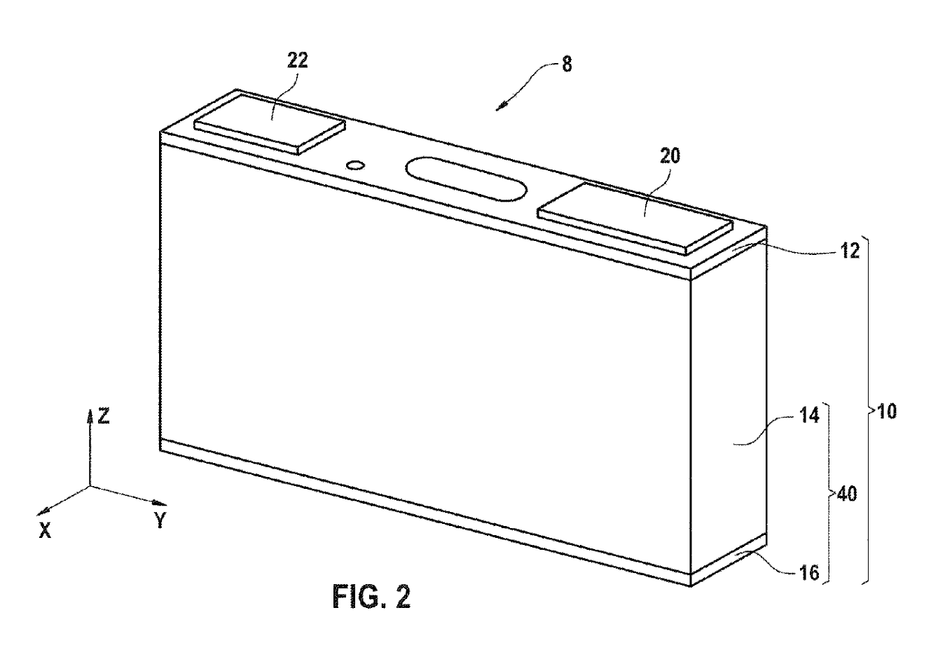

A three-dimensional coordinate system with an X, Y and Z axis is used below and applies to FIGS. 2 to 5.

FIG. 2 shows a perspective view of a battery cell 8 according to the invention according to a first embodiment in the three-dimensional coordinate system.

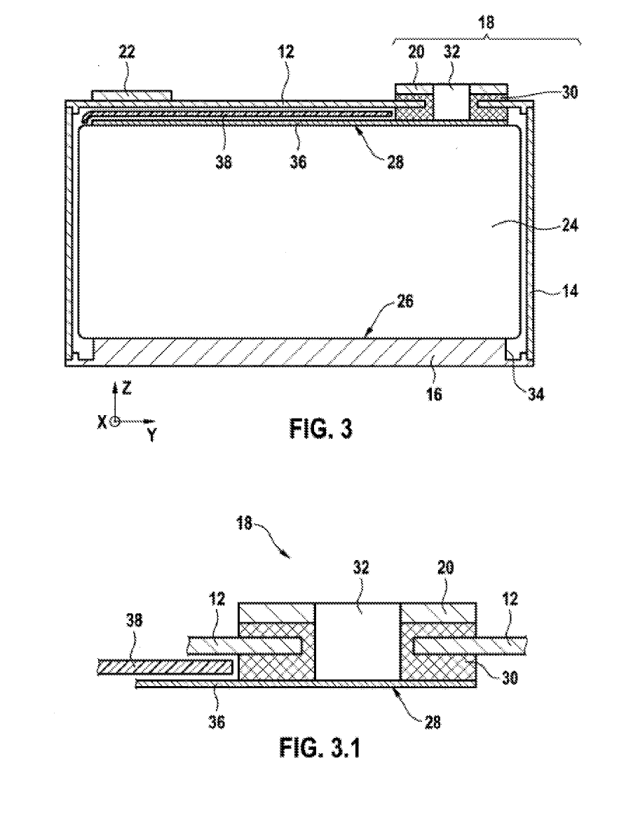

The battery cell 8 is of substantially rectangular and flat design. There is a battery roll 24 (cf FIG. 3) in a housing 10 of the battery cell 8, wherein the battery roll 24 is, in particular, embodied as a lithium-ion storage cell of flat design without an inherently rigid sleeve. Furthermore, the battery cell 8 has a first terminal 20 and a second terminal 22. The housing 10 of the battery cell 8 comprises a metallic cover part 12, a metallic wall part 14 and a metallic bottom part 16. In this case, the metallic wall part 14 and the metallic bottom part 16 form a box 40.

FIG. 3 shows a sectional view of the battery cell 8 according to the invention in accordance with the first embodiment in the Y-Z plane of the three-dimensional coordinate system.

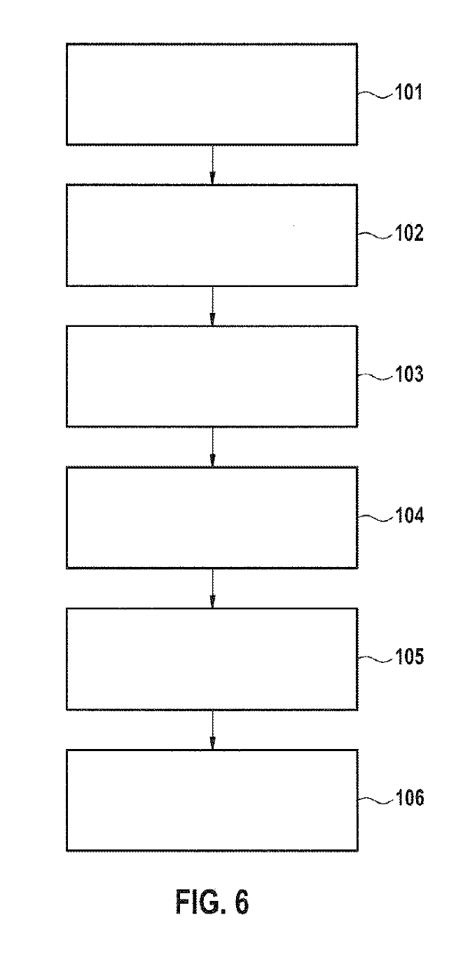

The battery roll 24 situated in the housing 10 is shown by way of in addition to FIG. 2, wherein the battery roll 24 has a first electrode side 26 and a second electrode side 28. Here, in contrast to the prior art, which is shown in FIG. 1, the battery roll 24 is turned through 90° about the X axis before the method according to the invention is carried out, i.e. the first electrode side 26 and the second electrode side 28 of the battery roll 24 are not perpendicular to the metallic cover part 12 and to the metallic bottom part 16 but are parallel to the metallic cover part 12 and to the metallic bottom part 16. The first electrode side 26 of the battery roll 24 is joined materially to the metallic bottom part 16. After the introduction of the battery roll 24 with the metallic bottom part 16 into the metallic wall part 14 and material joining of the metallic bottom part 16 to the metallic wall part 14, the metallic bottom part 16 and the box 40 obtained by joining the metallic bottom part 16 materially to the metallic wall part 14 are fully at a potential of the first electrode side 26. The second electrode side 28 of the battery roll 24 has a contact tab 36, and the second electrode side 28 is joined materially to a feedthrough bushing 32 via the contact tab 36. The first terminal 20 and the feedthrough bushing 32 as well as a sealing and insulating part 30 form a battery connection 18, wherein the feedthrough bushing 32 protrudes through the metallic cover part 12 and the sealing and insulating part 30 and is connected to the first terminal 20. The metallic cover part 12 is joined materially to the box 40 formed from the metallic wall part 14 and the metallic bottom part 16, wherein an insulating element 38 is installed between the metallic cover part 12 and the contact tab 36 of the second electrode side 28 of the battery roll 24. When joining the first electrode side 26 materially to the metallic bottom part 16, it should be noted that the metallic bottom part 16 contains a step 34 and/or that the first electrode side 26 of the battery roll 24 is enlarged in the direction of the metallic bottom part 16 (i.e. in the Z direction of the three-dimensional coordinate system) by a further contact tab 37 (cf FIG. 6). In the course of the method, the second terminal 22 can be mounted on the metallic cover part 12 or integrated into the latter.

FIG. 3.1 shows a detail view of a battery connection 18 of the battery cell 8 according to the invention according to the first embodiment.

As illustrated in FIG. 3.1, the feedthrough bushing 32 extends through the sealing and insulating part 30 and the metallic cover part 12 and is connected to the first terminal 20. The contact tab 36 of the second electrode side 28 of the battery roll 24 is joined materially to the feedthrough bushing 32. The insulating element 38 is installed between the metallic cover part 12 and the contact tab 36 of the second electrode side 28 of the battery roll 24.

In comparison with the solution according to the invention shown in FIGS. 2, 3 and 3.1, assembly of the battery arrangement 100 according to the prior art, which is illustrated in FIG. 1, is complex and expensive.

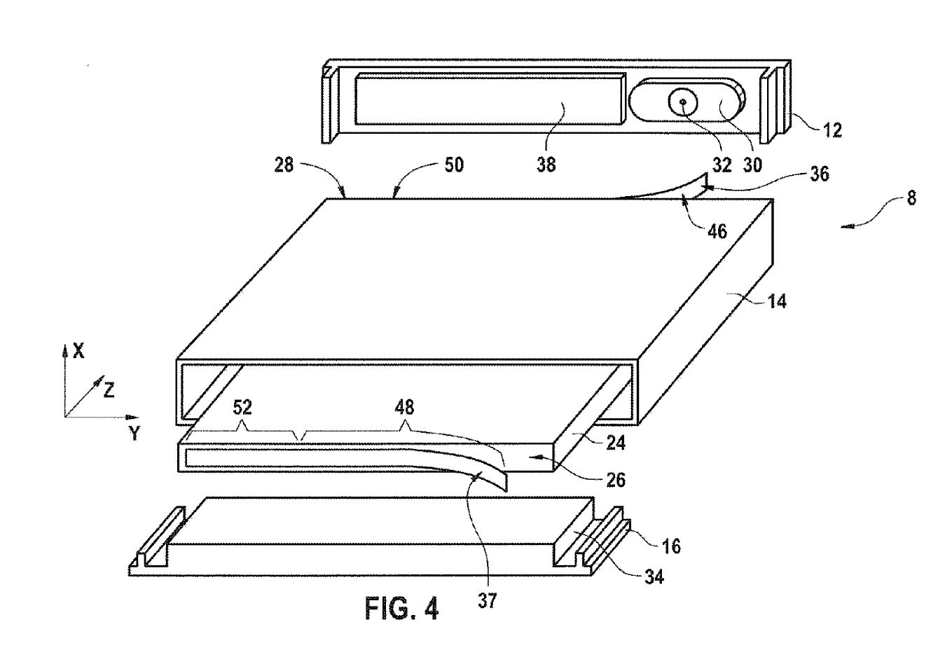

A second embodiment of the battery cell 8 according to the invention is shown in FIG. 4. Here, the metallic bottom part 16 is joined materially to the first electrode side 26 of the battery roll 24 of the battery cell 8 after introduction of the battery roll 24 into the metallic wall part 14. In the embodiment in FIG. 4, the first electrode side 26 has, for this purpose, a further contact tab 37, wherein the further contact tab 37 is joined materially to the metallic bottom part 16. The contact tab 36 has a fastening portion 50 and a deflected end 46. The fastening portion 50 of the contact tab 36 is attached to the second electrode side 28, while the deflected end 46 of the contact tab 36 is joined materially and so as to be flat to the feedthrough bushing 32, which extends through the metallic cover part 12 and the sealing and insulating part 30. An insulating element 38 is installed between the metallic cover part 12 and the contact tab 36. The further contact tab 37 has a fastening portion 52 and a deflected end 48. By means of the fastening portion 52, the further contact tab 37 is attached to the first electrode side 26 of the battery roll 24, while the deflected end 48 is connected materially and so as to be flat to the metallic bottom part 16. In this case, the metallic bottom part 16 can be produced with or without the step 34. Here, the metallic cover part 12 and the metallic bottom part 16 can be situated laterally next to the metallic wall part 14. After material joining of the metallic bottom part 16 to the metallic wall part 14, the metallic cover part 12 is placed on the box 40 formed from the metallic wall part 14 and the metallic bottom part 16 and is joined materially thereto.

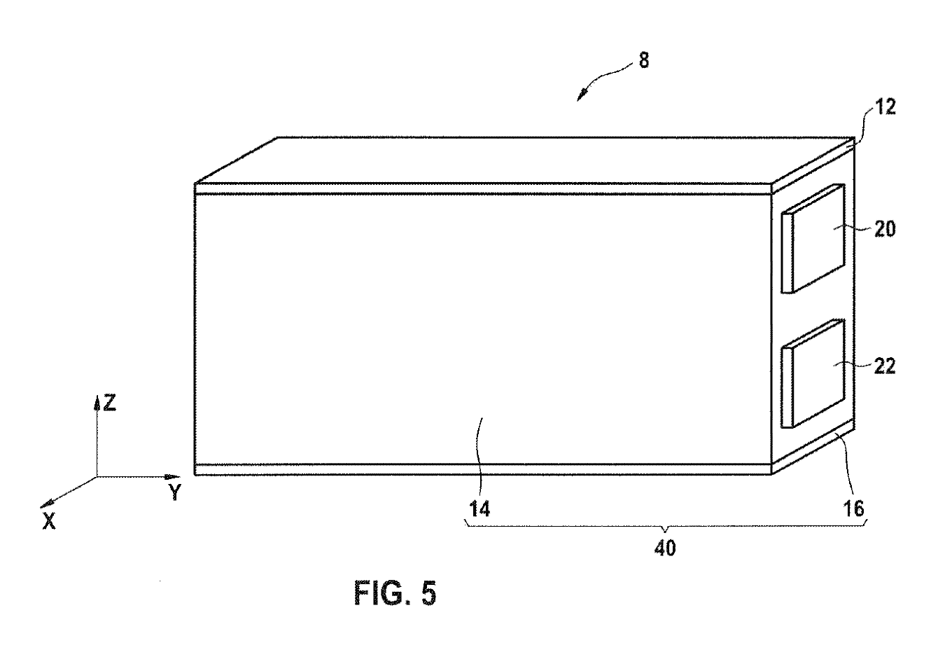

FIG. 5 shows a battery cell 8 according to the invention according to a third embodiment. The battery cell 8 has the first terminal 20, the second terminal 22, the metallic cover part 12, the metallic wall part 14 and the metallic bottom part 16. Here, the two terminals 20 and 22 are not mounted on the metallic cover part 12 but are arranged on the narrow side of the metallic wall part 14. One of the two contact tabs 36 and 37 (cf FIG. 4) is joined materially to the feedthrough bushing 32 (cf FIGS. 3 to 4), which extends through a narrow side of the metallic wall part 14, and is connected to the first terminal 20, while the other contact tab is mounted on the housing 10. The second terminal 22 can be mounted on the narrow side of the metallic wall part 14 in the course of the method according to the invention. After the metallic bottom part 16 has been joined materially to the metallic wall part 14, the metallic cover part 12 is placed on the box 40 formed from the metallic wall part 14 and the metallic bottom part 16 and is joined materially thereto.

A schematic sequence of one embodiment of the method according to the invention is shown in FIG. 6.

As shown in FIG. 3, the battery roll 24 is turned through 90° before the method is carried out. In a first step 101, the first electrode side 26 of the battery roll 24 is joined materially to the metallic bottom part 16 of the housing 10 of the battery cell 8, welding being a preferred candidate for consideration in this case. In principle, there is also the possibility of using other material joining methods, e.g. soldering, brazing, adhesive bonding or the like.

In a second step 102, the metallic bottom part 16 and the battery roll 24 are introduced into the metallic wall part 14 of the housing 10 of the battery cell 8. In a third step 103, the metallic bottom part 16 is joined materially to the metallic wall part 14, thus forming a box 40. In a fourth step 104, the contact tab 36 of the second electrode side 28 of the battery roll 24 is joined materially to the feedthrough bushing 32, which extends through the metallic cover part 12 of the housing 10 of the battery cell 8 and through the sealing and insulating part 30 and is connected to the first terminal 20. In a fifth step 105, the metallic cover part 12 is joined materially to the box 40 obtained in the third step 103. In a sixth step 106, a second terminal 22 is mounted directly on the metallic cover part 12 or is integrated into the latter.

The invention is not restricted to the illustrative embodiments described here or to the aspects emphasized therein. On the contrary, a large number of modifications that fall within the range of what a person skilled in the art would do is possible within the scope defined by the claims.

What is claimed is:

1. A method for producing a battery cell (8), comprising a housing (10) and a battery roll (24) arranged in the housing (10), wherein the battery roll (24) has a first electrode side (26) and a second electrode side (28), the method comprising the following steps:
joining the first electrode side (26) of the battery roll (24) materially to a metallic bottom part (16) of the housing (10) before or after introduction of the battery roll (24) into a metallic wall part (14) of the housing (10), and
joining the second electrode side (28) of the battery roll (24) materially to a feedthrough bushing (32) after the introduction of the battery roll (24) into the metallic wall part (14), wherein,
after the metallic bottom part (16) has been joined materially to the metallic wall part (14) and the second electrode side (28) has been joined materially to the feedthrough bushing (32), a metallic cover part (12) is joined materially to the metallic wall part (14), and wherein the material joining of the metallic bottom part (16) to the metallic wall part (14) takes place only after the material joining of the first electrode side (26) of the battery roll (24) to the metallic bottom part (16).

2. The method according to claim 1, characterized in that the second electrode side (28) has a contact tab (36), and the second electrode side (28) is joined materially to the feedthrough bushing (32) via the contact tab (36), wherein the feedthrough bushing (32) protrudes through the metallic cover part (12) or the metallic wall part (14) and is connected to a first terminal (20).

3. The method according to claim 2, characterized in that an insulating element (38) is installed between the metallic cover part (12) and the contact tab (36) of the second electrode side (28) of the battery roll (24).

4. The method according to claim 1, characterized in that at least one of the metallic cover part (12) and the metallic wall part (14) has a second terminal (22) connected thereto.

5. The method according to claim 1, characterized in that the metallic wall part (14) is prismatic.

6. The method according to claim 1, characterized in that the metallic bottom part (16) contains a step (34).

7. The method according to claim 1, characterized in that the first electrode side (26) of the battery roll (24) is enlarged in the direction of the metallic bottom part (16) by a further contact tab (37).

8. The method according to claim 7, characterized in that the metallic bottom part (16) contains a step (34).

9. The method according to claim 1, characterized in that a battery connection which is associated with the first electrode side (26) of the battery roll (24) of the battery cell (8) is embodied without a seal and/or without additional components.

10. A battery cell (8) produced by a method according to claim 1.

11. The battery cell (8) according to claim 10, characterized in that the metallic bottom part (16) and a box (40) formed from the metallic wall part (14) and the metallic bottom part (16) are at a potential of the first electrode side (26) and serve as current collectors.
